(19) United States
(12) Patent Application Publication
(10) Pub. No.: US 2010/0008692 A1
(43) Pub. Date: Jan. 14, 2010

(54) IMAGE FORMING APPARATUS AND CONTROL METHOD THEREOF

(75) Inventors: Tae-kyun KIM, Seongnam-si (KR); Woo-jung SHIM, Suwon-si (KR); Yoon-seop EOM, Suwon-si (KR); Jung-hwan KIM, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/473,772

(22) Filed: May 28, 2009

(30) Foreign Application Priority Data
Jul. 11, 2008 (KR) 2008-67551

(51) Int. Cl. G03G 15/00; G03G 15/08

(52) U.S. Cl. 399/88; 399/285

(57) ABSTRACT

An image forming apparatus including a power supply unit which supplies high voltage AC power, a developing unit having at least one developing roller to receive first AC power from the power supply unit to supply a developer to an image receptor, and an erasing unit to receive second AC power to attenuate high frequency noise of the developing unit.

### CROSS-REFERENCE TO RELATED APPLICATIONS

This application claims priority from Korean Patent Application No. 10-2008-0067551, filed on Jul. 11, 2008, in the Korean Intellectual Property Office, the disclosure of which is incorporated herein by reference in its entirety.

### BACKGROUND

1. Field of the Invention

Example embodiments of the present general inventive concept relate to an image forming apparatus and a control method thereof, and more particularly, to an image forming apparatus which receives high voltage AC power, and a control method thereof.

2. Description of the Related Art

An electrophotographic image forming apparatus such as a laser printer, a facsimile, a digital photocopier forms an image to be printed on paper as a print medium through image forming processes including charging, exposing, developing, transferring and fusing processes.

During the developing process of the image forming processes, a digital image signal is changed to an optical signal to form an electrostatic latent image on an image receptor such as an organic photo conductor (OPC) drum, and then a predetermined toner as a developer is attached to the formed electrostatic latent image. The attached toner is pressed to the paper at high temperatures through a fusing process and then discharged to the outside of the image forming apparatus.

The developing process is divided into a contact type and a non-contact type depending on whether the image receptor contacts the developing roller. The non-contact developing process enables less contamination by a developer and fast execution.

FIG. 1 illustrates a non-contact developing process of a conventional image forming apparatus.

As shown therein, an image forming apparatus 10 includes a power supply unit 100, a developing unit 200 having at least one developing roller and an image receptor 300 such as an OPC drum. The image forming apparatus 10 transfers a toner by the non-contact method through a gap d between the developing roller and the OPC drum.

The power supply unit 100 includes a high voltage power supply (HVPS) which applies high voltage DC and AC power to the developing roller to effectively transfer the toner to the OPC drum. The applied high voltage AC power may have approximately 2.5 kHz high frequency.

While raising developing efficiency by forming a toner cloud between the developing roller and the OPC drum, high-voltage AC power compresses and expands air particles existing in the gap d between the developing roller and the OPC drum and generates an acoustic wave that has the same frequency as the applied AC power does.

The generated acoustic wave is included within audible frequency range, being acknowledged as uncomfortable sound, i.e. noise. For example, an acoustic wave which has about 2.5 kHz frequency, generates high frequency noise of approximately 32.24 dB.

Generally, the image forming apparatus 10 generates mechanical noise as well as the high frequency noise. Recently, as efforts have been made to reduce the mechanical noise, the high frequency noise is becoming more distinctive, and the needs for reducing the noise are rising.

However, since the high frequency noise typically includes a long acoustic wave, it is difficult to reduce by using an acoustic absorbent. Moreover, due to the structural features of the image forming apparatus 10 having the fusing unit, there are a lot of limitations in using a blocking member.

### SUMMARY OF THE INVENTION

Example embodiments of the present general inventive concept can provide an image forming apparatus having reduced high frequency noise, and a control method thereof.

Additional embodiments of the present general inventive concept will be set forth in part in the description which follows and, in part, will be obvious from the description, or may be learned by practice of the present general inventive concept.

Example embodiments of the present general inventive concept provide an image forming apparatus, including a power supply unit to supply high voltage AC power, a developing unit having at least one developing roller to receive first AC power from the power supply unit to supply a developer to an image receptor, and an erasing unit to receive second AC power to attenuate high frequency noise of the developing unit.

A distance between the erasing unit and the developing roller may be a value that adds or deducts a predetermined value to/from a multiple of a wavelength of the first AC power.

The first and second AC power may have the same phase.

The first and second AC power may have opposite phases.

At least one of a voltage and a frequency of the first and second AC power may be the same.

The erasing unit may include an erasing roller.

The developing roller may include a first developing roller and a second developing roller including the erasing roller.

A phase difference between the first and second AC power may be larger than 120° and smaller than 240°.

Example embodiments of the present general inventive concept also provide a control method of an image forming apparatus which can include a power supply unit to supply high voltage AC power and a developing unit having at least one developing roller, the control method including applying first AC power from the power supply unit to the developing unit to supply a developer to an image receptor, and attenuating high frequency noise generated by the first AC power by applying second AC power to an erasing unit.

A distance between the erasing unit and the developing roller may be a value that adds or deducts a predetermined value to/from a multiple of a wavelength of the first AC power.

The first and second AC power may have the same phase.

The first and second AC power may have opposite phases.

At least one of voltage and frequency of the first and second AC power may be the same.

The erasing unit may include an erasing roller.

The developing roller may include a first developing roller and a second developing roller including the erasing roller.

A phase difference between the first and second AC power may be larger than 120° and smaller than 240°.

Example embodiments of the present general inventive concept can also provide a power supply unit to supply power to an image forming apparatus having at least one developing roller and an image receptor, the power supply unit including a first power supply unit to supply a first AC power to the at least one developing roller to transfer toner between the developing roller and the image receptor, the first AC power generating a first sound wave between the at least one developing roller and the image receptor, and a second power supply unit to supply a second AC power to the image forming apparatus to generate a second sound wave between the at least one developing roller and the image receptor to attenuate the first sound wave.

The second AC power can be supplied to an erasing roller of the image forming apparatus while the first AC power is supplied to the at least one developing roller.

The second AC power can be supplied to one of the developing rollers while the first AC power is supplied to another one of the developing rollers.

The phase of the first AC power can differ from the phase of the second AC power by a predetermined angle.

Example embodiments of the present general inventive concept can also provide a method of controlling an image forming apparatus having at least one developing roller and an image receptor, the method including applying a first AC power to the at least one developing roller to transfer toner between the developing roller and the image receptor, the first AC power generating a first sound wave between the at least one developing roller and the image receptor, and applying a second AC power to the image forming apparatus to generate a second sound wave between the at least one developing roller and the image receptor to attenuate the first sound wave.

Example embodiments of the present general inventive concept can also provide an image forming apparatus, including a power supply unit to supply AC power, and a developing unit including a plurality of developing rollers, wherein when one of the plurality of developing rollers receives a first AC power from the power supply unit, another one of the developing rollers receives a second AC power from the power supply unit which attenuates high frequency noise of the developing unit.

The another one of the developing rollers that receives the second AC power can be an erasing roller.

Any one of the plurality of developing rollers can selectively receive the second AC power.

### BRIEF DESCRIPTION OF THE DRAWINGS

These and/or other embodiments of the present general inventive concept will become apparent and more readily appreciated from the following description of the embodiments, taken in conjunction with the accompanying drawings of which:

FIG. 1 illustrates a developing process of a conventional image forming apparatus;

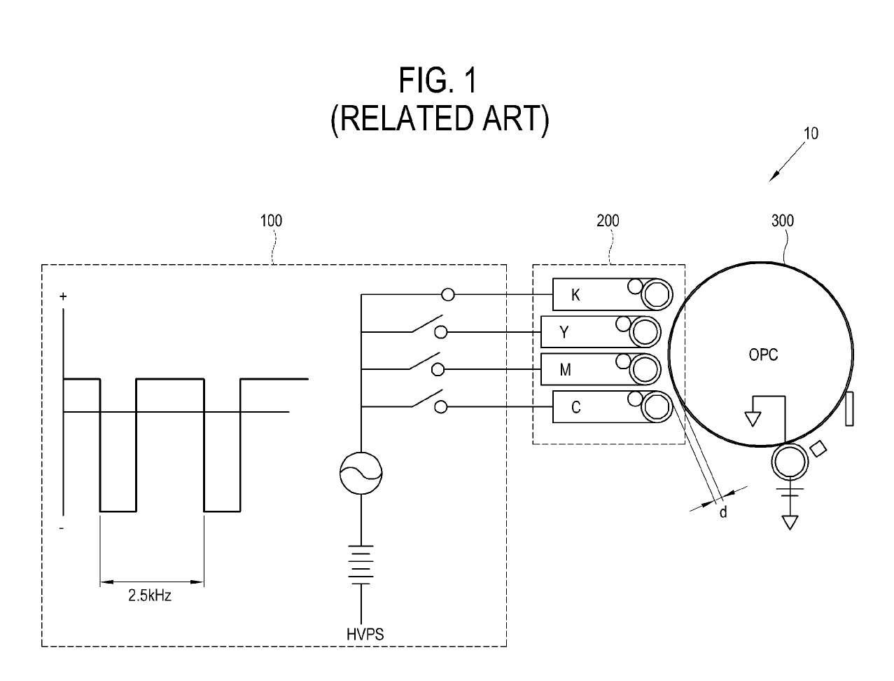

FIG. 2 illustrates an image forming apparatus according to an embodiment of the present general inventive concept;

FIG. 3 illustrates a configuration of a power supply unit according to an embodiment of the present general inventive concept;

FIG. 4 illustrates a wavy pattern of high frequency noise occurring depending on a distance between a noise source and an erasing source while phases of first AC power and second AC power are reverse;

FIG. 5 illustrates a wavy pattern of high frequency noise occurring depending on a distance between a noise source and an erasing source while phases of first AC power and second AC power are the same;

FIG. 6 illustrates an image forming apparatus according to another embodiment of the present general inventive concept;

FIG. 7 illustrates attenuation effects of high frequency noise according to the embodiment of FIG. 6; and

FIG. 8 is a flowchart to describe a control method of the image forming apparatus according to example embodiments of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

An image forming apparatus 10 according to example embodiments of the present general inventive concept may include a laser printer, a facsimile or a digital photocopier which forms an image in an electrophotographic method.

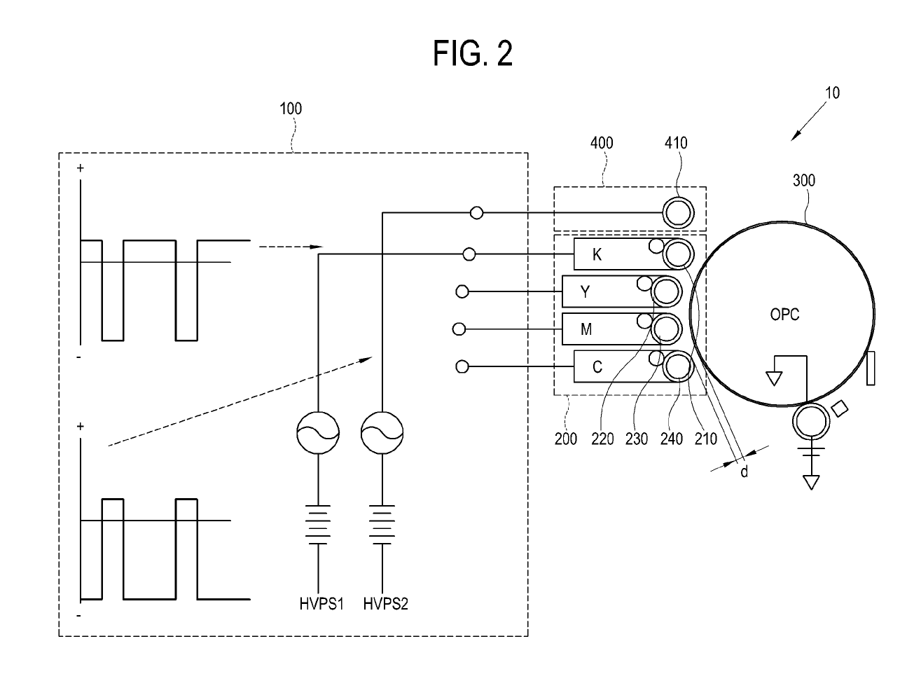

FIG. 2 illustrates an image forming apparatus 10 according to an exemplary embodiment of the present general inventive concept.

As illustrated therein, the image forming apparatus 10 can include a power supply unit 100, a developing unit 200 having at least one of developing rollers 210, 220, 230 and 240, an image receptor 300 such as an organic photo conductor (OPC) drum and an erasing unit 400. The image forming apparatus 10 can transfer a toner to a gap d between the developing roller and OPC drum through a non-contact method.

The power supply unit 100 may include a high voltage power supply (HVPS) to apply high voltage DC and AC power to the developing rollers 210, 220, 230 and 240 and the erasing unit 400.

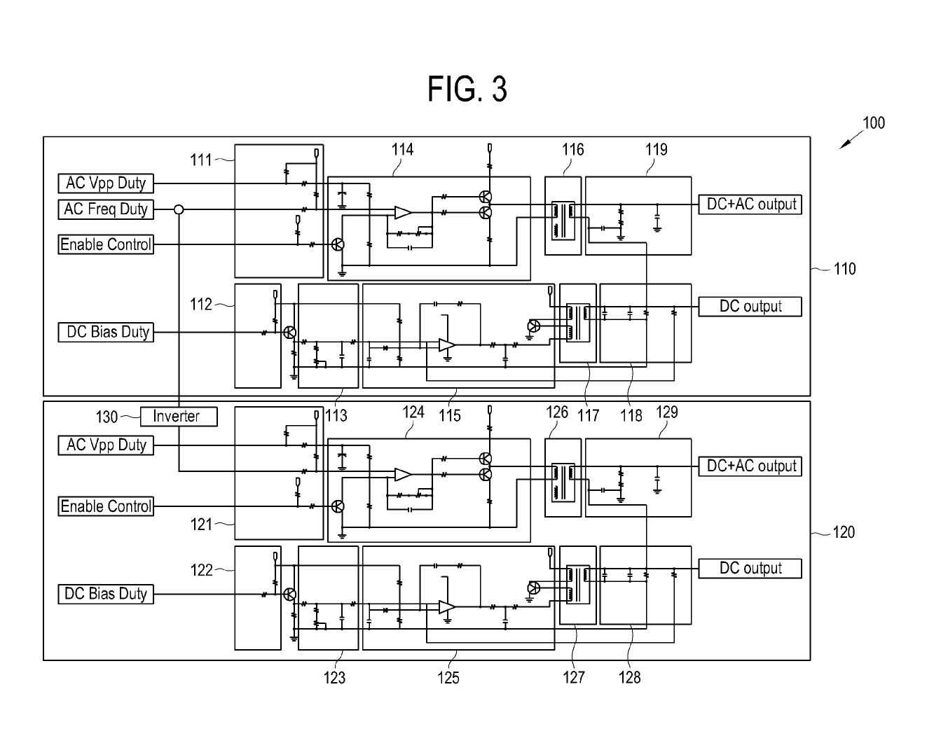

FIG. 3 illustrates a configuration of the power supply unit 100 according to an embodiment of the present general inventive concept.

As illustrated therein, the power supply unit 100 can include a first power supply unit 110 and a second power supply unit 120.

The first power supply unit 110 can apply high voltage DC and AC power to the developing unit 200 having at least one of the developing rollers 210, 220, 230 and 240.

More specifically, the first power supply unit 110 can include an AC signal input unit 111 to generate AC power, a DC signal input unit 112 to generate DC power, a low pass filter (LPF) 113 to filter the inputted DC power, an AC switching controller 114 to switch the generated AC power, a DC switching controller 115 to switch DC power, an AC converter 116 to flow AC power from the primary side to the secondary side according to a control of the AC switching controller 114, a DC converter 117 to flow DC power from the primary side to the secondary side according to a control of the DC switching controller 115, a rectifier 118 to convert AC power into DC power and a signal output unit 119 to output a signal superposing high voltage DC power and AC power.

Referring to FIG. 2, the first AC power which is outputted by the first power supply unit 110 may include a rectangular wave that has approximately 2.5 kHz frequency and voltages at several thousands of volts. The first power supply unit 110 can adjust the level of the applied DC power to apply positive and negative pressures asymmetrically. The first power supply unit 110 can also adjust properties by +/− duty ratio of the frequency of the applied AC power.

That is, as illustrated in FIG. 3, the first power supply unit 110 can control frequency, amplitude and average value of high voltage DC and AC power through pulse width modulation (PWM) including DC bias duty, AC frequency duty and AC vpp duty. The DC bias duty can control the size of the DC component among DC and AC power, the AC vpp duty can control peak-to-peak levels of the AC component, and the AC frequency duty can control frequency and duty of the AC component. The first power supply unit 110 may enable/disable high voltage DC and AC power through a control signal.

The second power supply unit 120 can apply high voltage AC power and DC power having a predetermined phase difference from the first power supply unit 110, to the erasing unit 400. Here, the second power supply unit 120 may include an inverter 130 to reverse the phase of the first AC power supplied by the first power supply unit 110.

The second power supply unit 120 can include an AC signal input unit 121 to generate AC power, a DC signal input unit 122 to generate DC power, a low pass filter (LPF) 123 to filter the inputted DC power, an AC switching controller 124 to switch the generated AC power, a DC switching controller 125 to switch DC power, an AC converter 126 to flow AC power from the primary side to the secondary side according to a control of the AC switching controller 124, a DC converter 127 to flow DC power from the primary side to the secondary side according to a control of the DC switching controller 125, a rectifier 128 to convert AC power into DC power and a signal output unit 129 to output a signal superposing high voltage DC power and AC power.

The second AC power which is outputted by the second power supply unit 120 may have a phase opposite to that of the first AC power, and a voltage and frequency, one of which is equal to that of the first AC power.

The developing unit 200 can include at least one of the developing rollers 210, 220, 230 and 240, and can supply a developer, i.e., a toner by a non-contact method through power supplied by the power supply unit 100. According to an exemplary embodiment of the present general inventive concept, the developing unit 200 can include four developing rollers 210, 220, 230 and 240 corresponding to cyan C, magenta M, yellow Y and black K. If the four developing rollers 210, 220, 230 and 240 are provided, the power supply unit 100 can sequentially apply power to each of the developing rollers 210, 220, 230 and 240 according to a developing processor.

The image receptor 300 can include an organic photo conductor (OPC) drum. The image receptor 300 can receive an optical signal from the developing unit 200 to form an electrostatic latent image, and can attach a predetermined toner supplied as a developer to the formed electrostatic latent image.

As illustrated in FIG. 3, there may be a gap d of approximately 200 μm between the developing rollers 210, 220, 230 and 240 and the image receptor 300 to supply a toner through a non-contact method. Accordingly, the high voltage first AC power may generate a first acoustic wave having the same frequency as the first AC power applied by compressing and expanding air particles existing in the gap d while forming a toner cloud to the gap d between the developing rollers 210, 220, 230 and 240 and the image receptor 300.

The erasing unit 400 can receive second AC power having a phase difference from the first AC power, from the second power supply unit 120. As illustrated in FIG. 3, the erasing unit 400 may include an erasing roller 410 which is distant from the developing rollers 210, 220, 230 and 240. There may also be a gap d having a predetermined distance between the erasing roller 410 and the image receptor 300. Thus, a second acoustic wave which has the same frequency as the second AC power may be generated. The first and second acoustic waves may create constructive or destructive interference depending on the distance and phase difference between the developing rollers 210, 220, 230 and 240 and the erasing roller 410. Wavy patterns of high frequency noise which occur according to the constructive or destructive interference may be amplified or attenuated

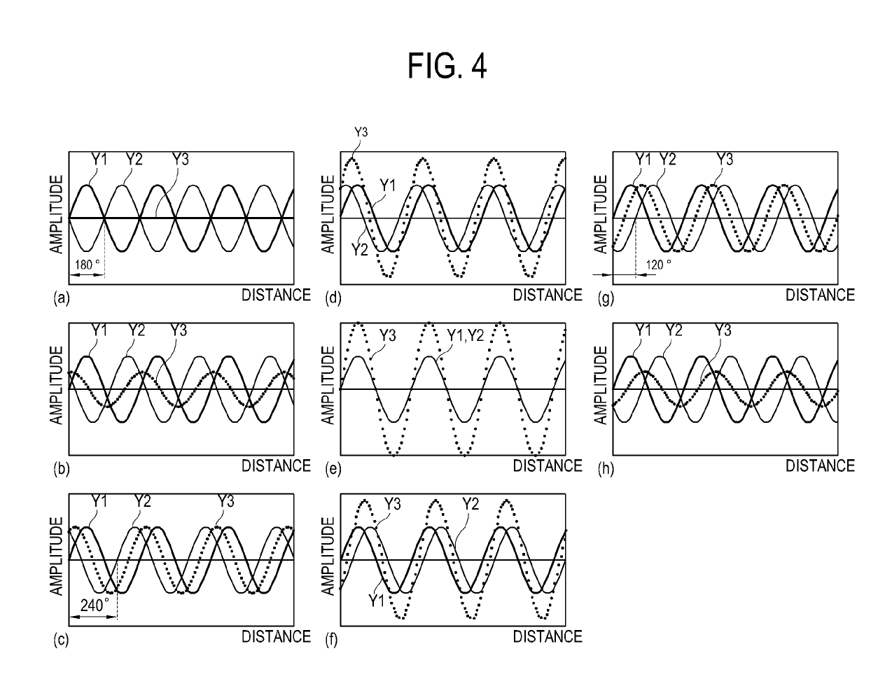

FIG. 4 illustrates a wavy pattern of high frequency noise that occurs according to the adjusted distance between the developing rollers 210, 220, 230 and 240 and the erasing roller 410 while the phases of first and second AC power are reverse.

Here, Y1 refers to a first acoustic wave generated by a first AC voltage, Y2 refers to a second acoustic wave generated by a second AC voltage and Y3 refers to a high frequency noise which occurs depending on constructive or destructive interference of Y1 and Y2.

If the phase difference between Y1 and Y2 is 180° as in (a) in FIG. 4, Y1 and Y2 attenuate to thereby remove the high frequency noise. That is, if the distance between the developing rollers 210, 220, 230 and 240 as a noise source generating Y1 and the erasing roller 410 as an erasing source generating Y2 is a multiple, the high frequency noise may be completely removed. For example, if the frequency of Y1 and Y2 is 2.5 kHz and the distance |A−B| between the noise source and erasing source is a multiple of 13.6 cm by a following formula 1, the high frequency noise removal may be maximum.

λ=c/f [Formula 1]

Here, C is the velocity of sound (340 m/s) and f is a frequency (2.5 kHz).

FIGS. 4 (a), (b) and (h) refer to erased high frequency noise. Here, the calculation result of amplifying or attenuating the high frequency according to the distance between the noise source and erasing source |A−B| may be represented by the following formula 2.

mλ<|A−B|<λ(m+⅙): attenuated

λ(m+⅙)<|A−B|<λ(m+⅚): amplified

|A−B|=λ(m+½): amplified at the maximum

λ(m+⅚)<|A−B|<λ(m+1): attenuated

|A−B|=mλ: attenuated at the maximum [Formula 2]

Here, m is a positive number.

If the phases of the first and second AC power are opposite to each other, the distance between the noise source and erasing source |A−B| may be a multiple of a wavelength λ of the first and second AC power, or the high frequency noise attenuates if predetermined values are added to or deducted from the multiple of the wavelength λ. For example, if m=0 in the formula 2 and the frequency of the AC power is 2.5 kHz, the high frequency noise attenuates. Here, |A−B| is 0-2.27 cm and 11.33-13.6 cm.

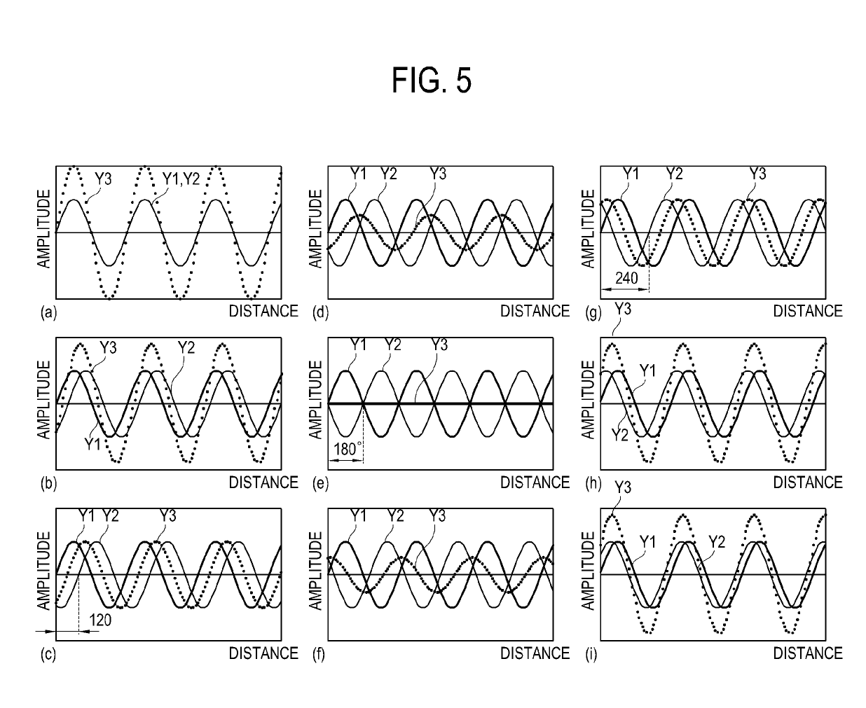

FIG. 5 illustrates a wavy pattern of high frequency noise occurring depending on the adjusted distance between the developing rollers 210, 220, 230 and 240 and the erasing roller 410 when the first and second AC power have the same phase.

Referring to FIG. 5, if the first and second AC power have the same phase and the distance between the noise source and erasing source |A−B| is a multiple of the wavelength λ, a wavy pattern Y3 of the high frequency noise may be amplified at the maximum.

FIGS. 5 (d), (e) and (f) refer to attenuated high frequency noise. Here, the calculation result of amplifying or attenuating the high frequency according to the distance between the noise source and erasing source |A−B| may be represented by the following formula 3.

mλ<|A−B|<λ(m+⅓): amplified

λ(m+⅓)<|A−B|<λ(m+⅔): attenuated

|A−B|=λ(m+½): attenuated at the maximum

λ(m+⅔)<A−B<λ(m+1): attenuated

|A−B|=mλ: amplified at the maximum [Formula 3]

Here, m is a positive number.

If the phases of the first and second AC power are the same, or if the distance between the developing rollers 210, 220, 230 and 240 and the erasing roller 410 |A−B| is a value that adds or deducts a predetermined value to/from a multiple of a wavelength λ of the first and second AC power, the high frequency noise can be attenuated. For example, if m=0 in the formula 3 and the frequency of the AC power is 2.5 kHz, the high frequency noise attenuates. Here, |A−B| is 4.53 cm-13.6 cm.

At the design phase of the image forming apparatus 10 according to embodiments of the present general inventive concept, the distance between the developing rollers 210, 220, 230 and 240 and the erasing roller 410 may be considered to reduce the high frequency noise. As a result, the first and second AC power may be applied by the same or reverse phases.

Referring to FIGS. 4a-4h and 5a-5i, if the phase difference between Y1 and Y2 is larger than 120° and smaller than 240°, a wavy pattern of Y3 attenuates. Thus, according to example embodiments of the present general inventive concept, the phase difference φ between the first and second AC power can meet the following formula 4 to attenuate high frequency noise while the distance between the developing rollers 210, 220, 230 and 240 and the erasing roller 410 |A−B| is fixed.

120°<Φ<240° [Formula 4]

Here, φ is a phase difference between the noise source and erasing source.

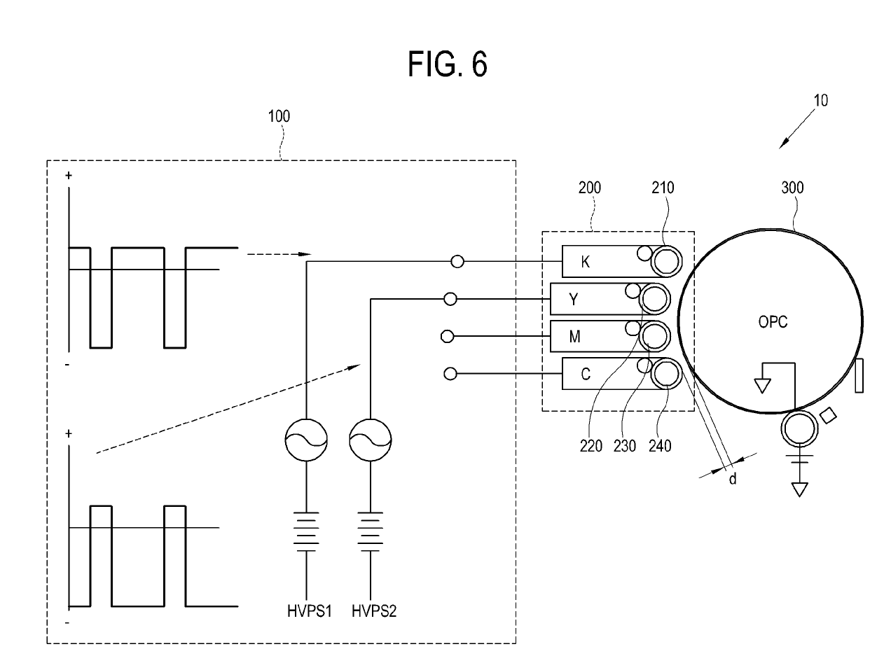

FIG. 6 illustrates an image forming apparatus 10 according to another exemplary embodiment of the present general inventive concept.

The image forming apparatus 10 according to this exemplary embodiment does not include the erasing unit 400. Instead, one of developing rollers 210, 220, 230 and 240 of a developing unit 200 can function as an erasing roller.

More specifically, if the developing unit 200 includes four developing rollers 210, 220, 230 and 240 corresponding to cyan C, magenta M, yellow Y and black K, a power supply unit 100 can sequentially apply power to each of the developing rollers 210, 220, 230 and 240 according to a developing processor.

Accordingly, the image forming apparatus 10 according to this exemplary embodiment can apply first AC power to the developing roller 210 corresponding to black color K to supply a toner, and at the same time can apply second AC power to one of remaining developing rollers 220, 230 and 240 to reduce high frequency noise. Similarly, the image forming apparatus 10 can apply first AC power to the developing roller Y corresponding to yellow color Y to supply a toner, and at the same time can apply second AC power to one of remaining developing rollers 210, 230 and 240 to reduce high frequency noise.

According to this exemplary embodiment of the present general inventive concept, the high frequency noise may be attenuated by sequentially applying the first and second AC power to the developing rollers 210, 220, 230 and 240. The power supply unit 100 may apply the first and second AC power by the same or reverse phase of the first and second AC power.

The amplification and attenuation of the high frequency noise can depend on the distance between the developing rollers 210, 220, 230 and 240 acting as noise sources and the erasing source can also apply to formulas 3 and 4.

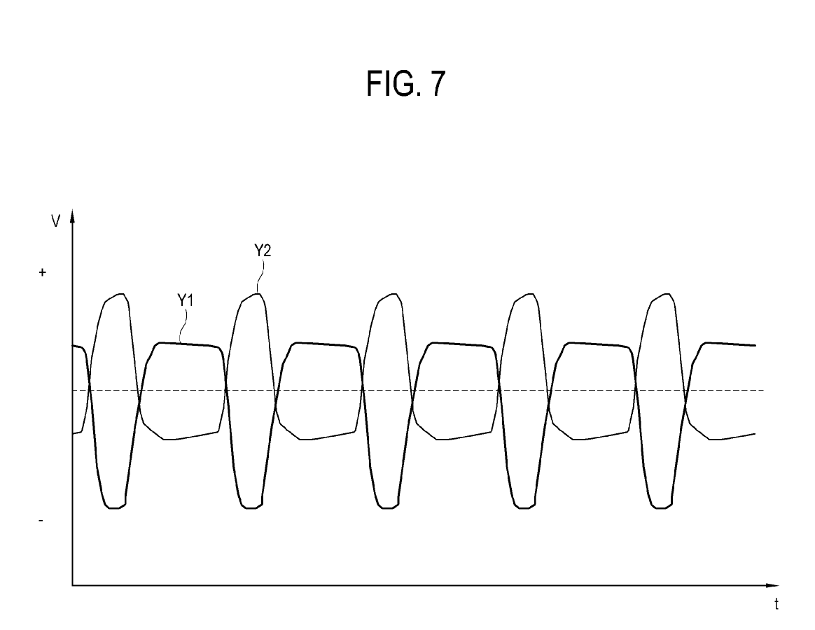

FIG. 7 illustrates attenuation effects of high frequency noise according to the exemplary embodiment of FIG. 6.

As illustrated in FIG. 7, the first AC power Y1 can be applied to the developing roller 210 corresponding to black color K, and the second AC power Y2 having the same frequency and amplitude as Y1 and reverse phase can be applied to the developing rollers 220, 230 and 240 corresponding to cyan C, yellow Y and magenta M. The result is illustrated in the following table 1.

TABLE 1

| classification | Case 1 | Case 2 | Case 3 | Case 4 |
|---|---|---|---|---|
| First AC power | K(210) | K(210) | K(210) | K(210) |
| applied | | | | |
| Second AC | — | C(240) | M(230) | Y(240) |
| power applied | | | | |
| Noise level | 66.0 | 63.7 | 67.8 | 69.7 |
| measured (dB) | | | | |

As illustrated in Table 1, if the first AC power is applied to the developing roller 210 corresponding to K to supply a toner, 66 dB high frequency noise may occur. If the second AC power is applied to the developing rollers 220, 230 and 240 corresponding to C, M and Y, the noise is reduced by about 2.3 dB to 63.7 dB with the developing roller 240 corresponding to cyan receiving the second AC power.

At the design phase, the distance between the developing rollers 210, 220, 230 and 240 of the image forming apparatus 10 according to the exemplary embodiment of FIG. 6 may be considered to reduce the high frequency noise. As a result, while the first AC power is applied to the developing roller to supply a toner, the second AC power may be applied to remaining developing rollers which have not received the first AC power, to thereby reduce high frequency noise.

Moreover, according to this exemplary embodiment of the present general inventive concept, the phase difference φ between the first and second AC power may be adjusted to be larger than 120° and smaller than 240° to thereby attenuate the high frequency noise.

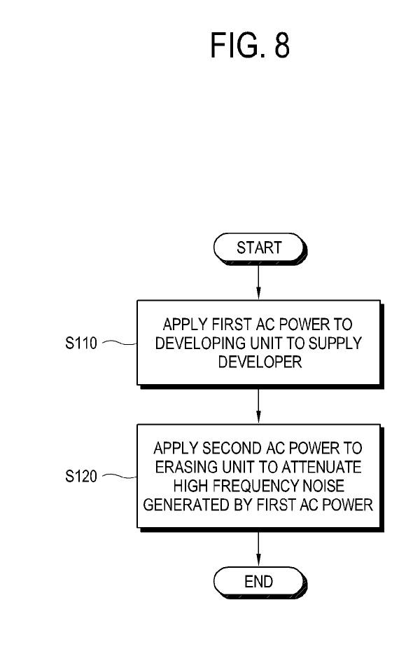

Hereinafter, a control method of reducing high frequency noise in the image forming apparatus 10 according to example embodiments of the present general inventive concept will be described with reference to FIG. 8.

The image forming apparatus 10 can include the power supply unit 100 to supply high voltage AC power, and the developing unit 200 can have at least one of the developing rollers 210, 220, 230 and 240. In operation S110, the developing unit 200 may receive first AC power from the power supply unit 100 to supply a developer to the image receptor 300.

In operation S120, the erasing unit 400 may receive the second AC power from the power supply unit 100 to attenuate the high frequency noise generated by the first AC power.

Here, the erasing unit 400 may include an additional erasing roller 410, or one of developing rollers that has not received the first AC power.

The first and second AC power may have the same or opposite phase. In this case, the distance between the erasing unit 400 and the developing rollers 210, 220, 230 and 240 may be a value that adds or deducts a predetermined value to/from a multiple of a wavelength of the first AC power.

At least one of the voltages and frequency of the first and second AC power may be the same. The phase difference between the first and second AC power may be larger than 120° and smaller than 240°.

According to example embodiments of the present general inventive concept, an image forming apparatus and a control method thereof may effectively reduce high frequency noise generated by high voltage AC power.

Although a few exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. An image forming apparatus, comprising:
a power supply unit to supply AC power;
a developing unit having at least one developing roller to receive first AC power from the power supply unit to supply a developer to an image receptor; and
an erasing unit to receive second AC power to attenuate high frequency noise of the developing unit.

2. The image forming apparatus of claim 1, wherein a distance between the erasing unit and the developing roller is a value that adds or deducts a predetermined value to/from a multiple of a wavelength of the first AC power.

3. The image forming apparatus of claim 2, wherein the first and second AC power have the same phase.

4. The image forming apparatus of claim 2, wherein the first and second AC power have opposite phases.

5. The image forming apparatus of claim 3, wherein at least one of a voltage and a frequency of the first and second AC power is the same.

6. The image forming apparatus of claim 4, wherein at least one of a voltage and a frequency of the first and second AC power is the same.

7. The image forming apparatus of claim 1, wherein the erasing unit comprises an erasing roller.

8. The image forming apparatus of claim 7, wherein the at least one developing roller comprises a first developing roller and a second developing roller including the erasing roller.

9. The image forming apparatus of claim 1, wherein a phase difference between the first and second AC power is larger than 120° and smaller than 240°.

10. A control method of an image forming apparatus which comprises a power supply unit to supply AC power and a developing unit having at least one developing roller, the control method comprising:
applying first AC power from the power supply unit to the developing unit to supply a developer to an image receptor; and
attenuating high frequency noise generated by the first AC power by applying second AC power to an erasing unit.

11. The control method of claim 10, wherein a distance between the erasing unit and the developing roller is a value that adds or deducts a predetermined value to/from a multiple of a wavelength of the first AC power.

12. The control method of claim 11, wherein the first and second AC power have the same phase.

13. The control method of claim 11, wherein the first and second AC power have opposite phases.

14. The control method of claim 12, wherein at least one of a voltage and a frequency of the first and second AC power is the same.

15. A power supply unit to supply power to an image forming apparatus having at least one developing roller and an image receptor, the power supply unit comprising:
a first power supply unit to supply a first AC power to the at least one developing roller to transfer toner between the developing roller and the image receptor, the first AC power generating a first sound wave between the at least one developing roller and the image receptor; and
a second power supply unit to supply a second AC power to the image forming apparatus to generate a second sound wave between the at least one developing roller and the image receptor to attenuate the first sound wave.

16. The power supply unit of claim 15, wherein the second AC power is supplied to an erasing roller of the image forming apparatus while the first AC power is supplied to the at least one developing roller.

17. The power supply unit of claim 15, wherein the second AC power is supplied to one of the developing rollers while the first AC power is supplied to another one of the developing rollers.

18. The power supply unit of claim 15, wherein the phase of the first AC power differs from the phase of the second AC power by a predetermined angle.

19. A method of controlling an image forming apparatus having at least one developing roller and an image receptor, the method comprising:
applying a first AC power to the at least one developing roller to transfer toner between the developing roller and the image receptor, the first AC power generating a first sound wave between the at least one developing roller and the image receptor; and
applying a second AC power to the image forming apparatus to generate a second sound wave between the at least one developing roller and the image receptor to attenuate the first sound wave.

20. The method of claim 19, wherein the second AC power is applied to an erasing roller of the image forming apparatus while the first AC power is applied to the at least one developing roller.

21. The method of claim 19, wherein the second AC power is applied to one of the developing rollers while the first AC power is applied to another one of the developing rollers.

22. An image forming apparatus, comprising:
a power supply unit to supply AC power; and
a developing unit including a plurality of developing rollers,
wherein when one of the plurality of developing rollers receives a first AC power from the power supply unit, another one of the developing rollers receives a second AC power from the power supply unit which attenuates high frequency noise of the developing unit.

23. The image forming apparatus of claim 22, wherein the another one of the developing rollers that receives the second AC power is an erasing roller.

24. The image forming apparatus of claim 22, wherein any one of the plurality of developing rollers can selectively receive the second AC power.
